(19) United States
(12) Patent Application Publication
(10) Pub. No.: US 2022/0217262 A1
(43) Pub. Date: Jul. 7, 2022

(54) METHOD FOR TRANSMITTING A RAW IMAGE DATA STREAM FROM AN IMAGE SENSOR

(71) Applicant: Schölly Fiberoptic GmbH, Denzlingen (DE)

(72) Inventors: Stefan SCHRÖER, Freiburg (DE); Johannes BOURBON, Freiburg (DE); Matthias KÜHN, Freiburg (DE); Michael SCHWARZLE, Denzlingen (DE); Lutz LABUSCH, Emmendingen (DE)

(73) Assignee: Schölly Fiberoptic GmbH, Denzlingen (DE)

(21) Appl. No.: 17/568,839

(22) Filed: Jan. 5, 2022

(30) Foreign Application Priority Data
Jan. 7, 2021 (DE) 102021100124.2

(51) Int. Cl. H04N 5/232; H04N 5/44; H04N 5/38

(52) U.S. Cl. CPC H04N 5/23206; H04N 5/38; H04N 5/44; H04N 5/23232

(57) ABSTRACT

A device (1) and a method for transferring a raw image data stream (8) from an image sensor (6) via a data transfer connection (4) between a transmitter (2) and a receiver (3). In this case, the latency of the data transfer connection (4) is determined (S1), and the data rate of the raw image data stream (8) at the transmitter (2) is adapted (S3) to the determined latency.

### TECHNICAL FIELD

The invention relates to a method for transferring a raw image data stream from an image sensor via a data transfer connection between a transmitter and a receiver.

### BACKGROUND

Methods of this type are known per se and are used in endoscopy, for example, in order to transfer a recorded image with as little loss of data as possible.

In this case, the data transfer connection can be of wireless or wired, optical or some other design. In principle, the data transfer connection can be disturbed or adversely affected by environmental influences, for example by magnetic fields or interference.

These disturbances can have the consequence that the bandwidth of the data transfer connection is reduced, such that the raw image data stream is transferrable only with a greater latency. Such latencies should be avoided particularly in surgical endoscopy.

In the prior art it is known, therefore, to transfer a compressed video image data stream rather than the raw image data stream. In this case, the compression rate can be adapted such that a latency is reduced or kept at a constant level. In this case, the raw image data stream differs from a video image data stream in the lack of generation of the color image.

This generation of the color image involves using the sensor pattern or pattern of the sensor or color filter, for example a Bayer pattern, in order to generate the different color channels of the color image from a greyscale image or a data field.

However, this necessitates generating the video image in the camera head of the endoscope, which necessitates complex and powerful hardware. Furthermore, some image editing processes are possible only with raw image data, and so the camera head has to have this image editing hardware as well. The costs and the energy demand of the camera head increase as a result, however.

### SUMMARY

The invention thus addresses the problem of reducing or keeping constant latencies during the transfer of raw image data streams.

This problem is solved by a method having one or more of the features disclosed herein and by a device having one or more of the features disclosed herein.

The method according to the invention is accordingly characterized by the following steps:

determining the current latency of the data transfer connection, and

adapting the data rate of the raw image data stream at the transmitter depending on the determined latency.

Therefore, unlike in the prior art, a video image is not subjected to stronger or weaker compression, rather the raw image data stream is adapted, i.e. altered, at the transmitter end such that the data rate to be transferred is reduced. As a result, a raw image data stream that can serve as a basis for all image editing processes is still available at the receiver end. Said processes can then be carried out at the receiver end. Accordingly, the complex image editing hardware can be arranged in the receiver. This has the advantage that no image editing hardware is required in the transmitter, for example a camera head of an endoscope. As a result, the power consumption of the transmitter is reduced as well. The transmitter can thus be produced more simply and more cheaply.

Adapting the data rate depending on the determined latency can comprise for example reducing the latency below a latency limit value and/or keeping the latency constant at a predefined target latency.

Determining the latency can be effected by measuring the bandwidth, for example. It is also possible to carry out a delay measurement, for example by means of embedded time stamps in the raw image data stream. Moreover, even further methods are known for determining the latency.

In one embodiment, the data rate is reduced if the latency exceeds a latency limit value. It is thus possible to ensure that a predefined, critical latency is not exceeded. In this case, the latency limit value can vary depending on the application. By way of example, the latency limit value during surgical endoscopy can be lower than that in diagnostic endoscopy.

In one embodiment, the data rate is reduced further as latency increases. It is thus possible to ensure that the latency limit value is complied with.

Preferably, as the latency decreases, the data rate is also adapted, such that the latter is increased again.

In one embodiment, the method is repeated regularly or continuously. This has the advantage that it is possible to react to varying latencies. Particularly in the case of wireless data transfer connections, the latency can change rapidly as a result of interference and other influences. The latency can be determined at fixed intervals, for example, wherein interval times typically of less than 10 seconds can be chosen. In this case, it is possible to determine the latency for example with the separating margin of the interval time on the basis of a single frame. However, it is also possible to observe the whole or a part of the interval time, such that a latency value averaged over the interval time can be determined.

In principle, the latency can be determined at the transmitter or at the receiver.

In one preferred embodiment, the latency is determined at the receiver.

There can then be a supervisory connection between transmitter and receiver, via which supervisory connection the receiver transfers supervisory data to the transmitter and adapting the data rate at the transmitter is effected on the basis of the supervisory data. As a result, it is possible to dispense with complex electronics in the transmitter, and so a simple determination is possible in the receiver. Furthermore, the latency occurs in the receiver and, consequently, the determined value is also the actual value.

The supervisory data can comprise the determined latency and/or control data. In this case, the transmitter can have a processor, for example, which generates corresponding control commands for an image sensor, for example, from the communicated latency.

It is particularly advantageous, however, if said control commands are already generated in the receiver and transferred as supervisory data to the transmitter. A simple microcontroller for forwarding the control commands can thus be sufficient at the transmitting end. As a result, it is possible to obtain a further reduction of the hardware complexity in the transmitter.

In one embodiment, adapting the data rate is effected by changing the resolution, the color depth and/or the frame rate of the raw image data stream. In this case, it is possible to define what parameter is preferably adapted. By way of example, firstly the resolution could be reduced to a specific first resolution. If a further reduction of the data rate is necessary, it is possible afterward to reduce the color depth to a first color depth and only afterward to reduce the resolution further. Overall, many different strategies are possible here, which can vary depending on the application. In this regard, in some applications it may be more important to have the full resolution, with possibly smaller color depth. In another application, the full color resolution may be crucial, but the frame rate may be unimportant since a rather static situation is present.

In one embodiment, the changing is locally weighted in the image. In this case, a greater reduction can be effected for example in insignificant parts of the image.

Preferably, such reduction strategies can be preconfigurable and can be storable as presettings, for example in the receiver.

In one embodiment, the resolution can be adapted after the digitization of the image sensor data. For this purpose, individual pixels can be combined by way of software, such that the number of pixels to be transferred decreases.

In one advantageous embodiment, adapting the resolution is effected by reconfiguring an image sensor, in particular by pixel binning. In this case, the number of pixels is already reduced before the digitization of the image sensor values, and so no computational complexity at all arises.

In one embodiment, adapting the color depth is effected after the digitization by way of software, for instance in a system on a chip (SoC), in the transmitter, wherein the color depth can be reduced in any desired way. The image sensor values can be digitized with 12 bits, for example. The color depth can thus subsequently be reduced to 11, 10, 9, 8 or fewer bits.

In one embodiment, adapting the color depth can be effected by digitizing the color values with a smaller number of bits. In this case, by way of example, a variable analog-to-digital converter can be used. In this way, subsequent computational complexity for reducing the color depth is no longer possible, for which reason for example an SoC in the transmitter can be dispensed with.

In one embodiment, the transmitter can adapt the color depth by cutting off one or more less significant bits per color value. By way of example, in the case of a 12-bit value, the least significant three bits can be cut off, such that only the nine more significant bits are transferred. Since the bits cut off generally contain noise, this results only in a low loss of image quality. The receiver adds the missing bits with virtual noise. The advantage here is that, in the example mentioned above, a 12-bit resolution is actually obtained, but only nine bits need be transferred. It goes without saying that more or fewer less significant bits can also be cut off, and/or a higher or lower original color depth can be present, for instance 14 bits.

In one embodiment, adapting the data rate is effected by combining pixels that occur characteristically redundantly in the pixel pattern.

This can be effected, for example, given the presence of a plurality of color values of identical type per pixel, by transferring not all, in particular only one, of the color values of identical type per pixel. By way of example, in the case of an RCCC color filter, just one C color value or two C color values can be transferred instead of all three C color values. A variable reduction of the data rate can be obtained as a result.

In one exemplary embodiment, the image sensor has a Bayer filter. A Bayer filter has one red subpixel, one blue subpixel, but two green subpixels, per pixel. Adapting the data rate can be effected here by transferring only one green value per pixel. If only the value of one of these subpixels is transferred, only three instead of four color values are transferred per pixel. The loss of quality is low in this case. For this purpose, by way of example, one of the two green values or a mean value formed from the two green values can be transferred.

In one embodiment, the data transfer connection is a wireless data connection, in particular a WiFi connection. Such WiFi connections can transfer very high data rates and are implementable in a simple manner by way of standard components.

A supervisory connection possibly present can likewise be wireless or wired; in particular, the supervisory connection can use the same transfer technique as the data transfer connection. However, it can also use a different transfer technique, such as Bluetooth, for example, since only small amounts of data need to be transferred here.

In one embodiment, the reduction of the data rate can additionally also be effected in the event of the transmitter having a low rechargeable battery level. The lower data rate requires a lower energy demand, such that the remaining life can be lengthened. In this case, the reduction of the data rate on the basis of the rechargeable battery level can be effected automatically or only after user confirmation.

The invention also encompasses a device for transferring a raw image data stream from an image sensor via a data transfer connection between a transmitter and a receiver, characterized by

means for determining the current latency of the data transfer connection, and

means for adapting the data rate of the raw image data stream at the transmitter depending on the determined latency.

In one embodiment, the means for determining the latency is arranged at the receiver and there is a supervisory connection between transmitter and receiver, via which supervisory connection the receiver can transfer supervisory data to the means for adapting the data rate, in particular wherein the supervisory data comprise the determined latency and/or control data.

In one embodiment, the transmitter has an image sensor, wherein the image sensor is configurable on the basis of the supervisory data. In this way, it is possible to configure for example pixel binning or some other reduction of the resolution or a smaller color depth at the image sensor level, i.e. still before the digitization of the image sensor values. As a result, the transmitter can be constructed in a very simple manner and requires only little in the way of electronics, for example a cost-effective microcontroller. Any image processing and image editing and also the generation of the supervisory data are thus effected in the receiver.

One advantageous configuration of the device according to the invention can provide for means to be designed for carrying out a method according to the invention, in particular as described above and/or as claimed in any of the claims directed to a method. Consequently, by way of example, the described advantages of the claimed method can be utilized in the context of the claimed device.

The image sensor can be any desired sensor for capturing electromagnetic radiation. The image sensor is preferably suitable for capturing electromagnetic radiation in a spatially resolved manner. Such an image sensor is for example a single photon avalanche diode (SPAD), a photomultiplier, an infrared sensor, a charged coupled device (CCD) or a CMOS image sensor. The image sensor can be for example an RGB, monochrome or HSI sensor.

In one embodiment, the transmitter has more than one image sensor, in particular two image sensors. The latter can for example be configured for stereo representation or cover different spectral ranges.

### BRIEF DESCRIPTION OF THE DRAWINGS

The invention is explained in greater detail below on the basis of examples with reference to the accompanying drawings.

In the figures:

FIG. 1 shows a flow diagram of a method according to the invention,

FIG. 2A shows a device according to the invention comprising a transmitter having one image sensor and a receiver,

FIG. 2B shows a device according to the invention comprising a transmitter having two image sensors and a receiver,

FIG. 3 shows a schematic illustration of the reduction of the resolution by pixel binning,

FIG. 4 shows a schematic illustration of the reduction of the color depth by selectively omitting color data, and

FIG. 5 shows a schematic illustration regarding the reduction of the color depth by cutting off less significant bits per color channel.

### DETAILED DESCRIPTION

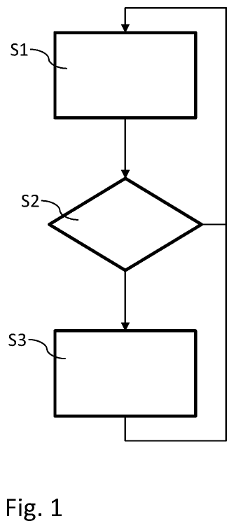

FIG. 1 shows a flow diagram of a method according to the invention for transferring a raw image data stream from a transmitter to a receiver via a data transfer connection. In a first step S1, the current latency of the data transfer connection is determined. This can be effected for example by ascertaining the transfer rate or by means of time stamps.

In surgical applications, it is important for the latency to be less than 80 ms. For a user, however, it may likewise be disturbing if the latency frequently changes or fluctuates. This may be disturbing even if the latency overall is low, i.e. for example changes continuously within 40 ms and 80 ms.

In a second step S2, the determined latency is now compared with a latency limit value. If the determined latency is greater than the latency limit value, in a third step S3 the data rate of the raw image data stream is reduced and the method is continued with the first step.

If the determined latency is less than the latency limit value, the method likewise continues with the first step S1.

Alternatively, it is possible here to check whether the data rate has already been reduced and the data rate can be increased again.

In order to change the data rate of the raw image data stream, the resolution, color depth and/or frame rate of said raw image data stream can be changed. Table 1 shows by way of example the data rate per second as a function of these three parameters and thus the potential for reducing the data rate. In this case, the maximum values for resolution, color depth and frame rate may differ depending on the image sensor and should therefore in no way be understood to be restrictive. In this regard, there are for example also image sensors with a color depth of 14 bits and/or higher resolution, for instance 4K.

TABLE 1

| Resolution | | Color depth | Frame rate | Data rate |
|---|---|---|---|---|
| 1920 | 1080 | 12 | 60 | 1,492,992,000 |
| 1920 | 1080 | 10 | 60 | 1,244,160,000 |
| 1920 | 1080 | 8 | 60 | 995,328,000 |
| 1920 | 540 | 12 | 60 | 746,496,000 |
| 960 | 540 | 12 | 60 | 373,248,000 |
| 480 | 1080 | 12 | 60 | 373,248,000 |
| 480 | 270 | 12 | 60 | 93,312,000 |
| 1920 | 1080 | 12 | 30 | 746,496,000 |
| 1920 | 1080 | 12 | 15 | 373,248,000 |
| 480 | 270 | 8 | 15 | 15,552,000 |

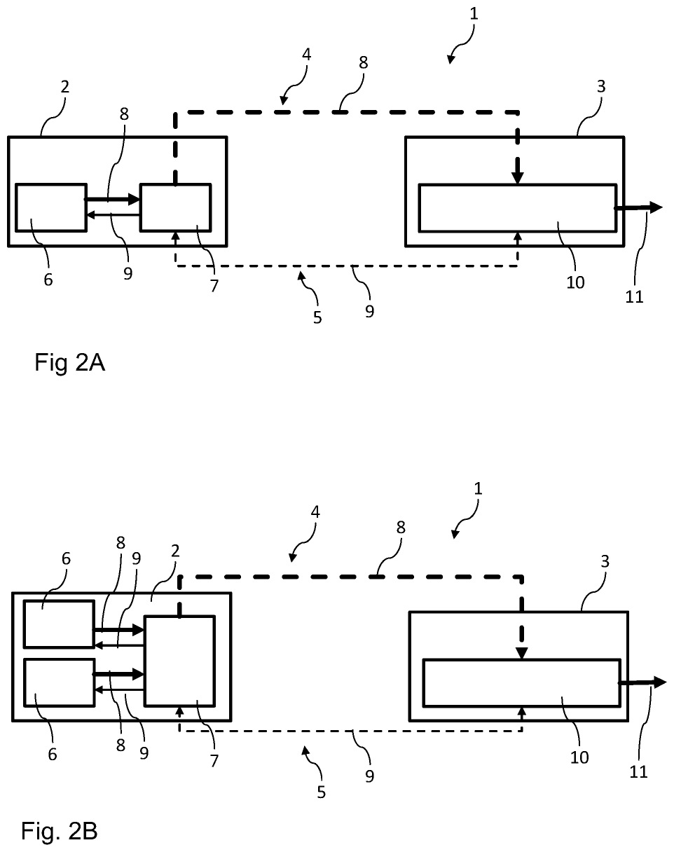

FIG. 2A shows a device 1 according to the invention comprising a transmitter 2 and a receiver 3, which are connected to one another via a data transfer connection 4 and a supervisory connection 5.

The device can be an endoscope, for example, wherein the transmitter 2 can be a camera head and the receiver can be a camera control unit (CCU).

The data transfer connection 4 and the supervisory connection 5 can be of wired, optical or wireless design. In the example, both are designed as a WiFi connection. Alternatively, the supervisory connection 5 can also be designed as a separate wireless connection, for instance as a Bluetooth connection or as a WiFi connection on a different band or at a different frequency than the data transfer connection 4, in order to have the full bandwidth available for the latter.

The receiver 3, for instance the CCU of an endoscope, has an image processing unit 10, which receives the raw image data stream 8 and converts the latter into a video image data stream 11 for an image display unit, for instance a monitor. The image processing unit 10 can also be designed for generating the supervisory data and/or control commands 9.

The receiver 3 additionally has according to the invention means for ascertaining the latency of the data transfer connection 4. This means can for example be integrated in the image processing unit 10, and for example be designed for evaluating time stamps in the raw image data stream.

The transmitter 2, for example the camera head of an endoscope, has an image sensor 6 and a control unit 7 connected to the image sensor 6.

In one embodiment, the control unit 7 is an SoC designed for changing a raw image data stream and for driving the image sensor 6.

In this embodiment, the control unit 7 receives a raw image data stream 8 of the image sensor 6 and transfers it to the receiver 3 via the data transfer connection 4.

The control unit 7 also receives supervisory data via the supervisory connection 5. From the supervisory data, the control unit ascertains control commands 9 for the image sensor and for changing the raw image data stream. In this embodiment, the control unit 7 can make changes according to the invention to the raw image data stream before the latter is forwarded to the data transfer connection 4.

In this case, the supervisory data can comprise the determined latency, for example, from which the control unit 7 then carries out suitable measures for changing the data rate according to the invention.

In an alternative embodiment, the control unit 7 is a simple microcontroller designed for receiving control commands 9 from the receiver and forwarding them to the image sensor 6 and for receiving a raw image data stream 8 from the image sensor 6 and forwarding it to the data transfer connection 4. All of the control commands 9 are generated in the receiver 3.

This embodiment has the advantage that there is practically no computational complexity in the transmitter and the control unit 7 can accordingly be designed very simply and cost-effectively.

In both embodiments, the image sensor 6 can be designed to be configurable by means of the control commands 9. As a result, the image sensor 6 can be read for example according to the invention with a lower resolution (pixel binning), color depth or frame rate. Particularly in the case of the last-mentioned embodiment, a variable reduction of the data rate is thus possible, without computing power being necessary or present in the transmitter.

In this case, what possibilities are available may also depend on the image sensor 6 present. In such a case, it is possible to compensate for a lack of configurability of an image sensor by means of a control unit 7 with an SoC (system on a chip), an ISP (image signal processor) or an FPGA (field programmable gate array) for the signal processing of the raw image data stream.

FIG. 2B shows a device 1 according to the invention, which device substantially corresponds to the device from FIG. 2A. In this embodiment, however, the transmitter has two image sensors 6, the raw image data of which are transferred via the one data transfer connection 4. These image sensors can be configured for stereoscopic representation, for example. However, by way of example, it is also possible for one image sensor to be designed for real image recording, and the other for capturing instances of fluorescence. The method according to the invention is then applied to both image sensors.

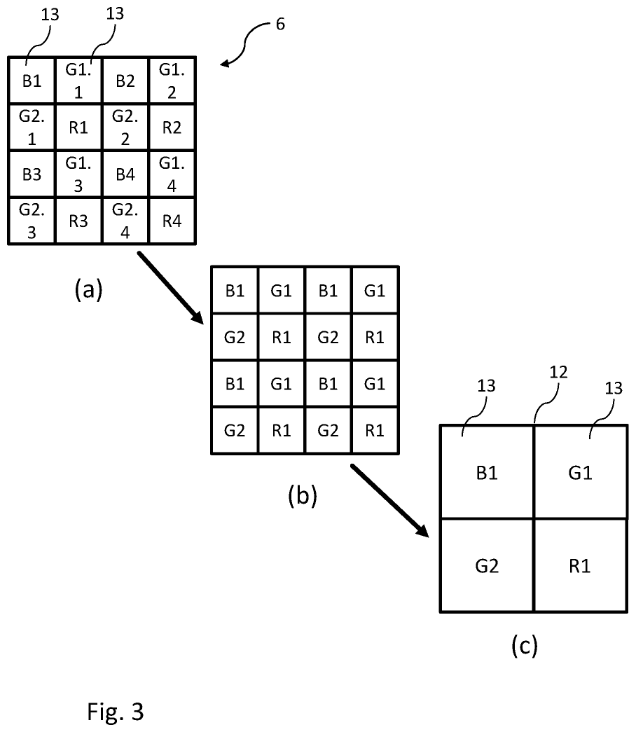

FIG. 3 shows by way of example a method for reducing the resolution of the image sensor. This reduction of the resolution can be effected by means of configuration of the image sensor or after the digitization by means of image editing.

In FIG. 3 at (a) a detail of an image sensor 6 with four pixels 12 is shown. The image sensor 6 in the example has a Bayer color filter. Each pixel 12 accordingly has four subpixels 13: one red subpixel R1-R4, one blue subpixel B1-B4 and two green subpixels G1.1-G2.4. In the example, the resolution is reduced to one quarter by means of a 2×2 pixel binning. For this purpose, the corresponding subpixels 13 of the four pixels 12 are in each case combined, which is illustrated in FIG. 3 at (b). FIG. 3 at (c) then shows the resulting pixel 12 such as is received at the receiver 3.

In this way, the resolution can also be reduced to other values, for example 1×2, 2×1, 2×2, 2×3, . . . , n×m.

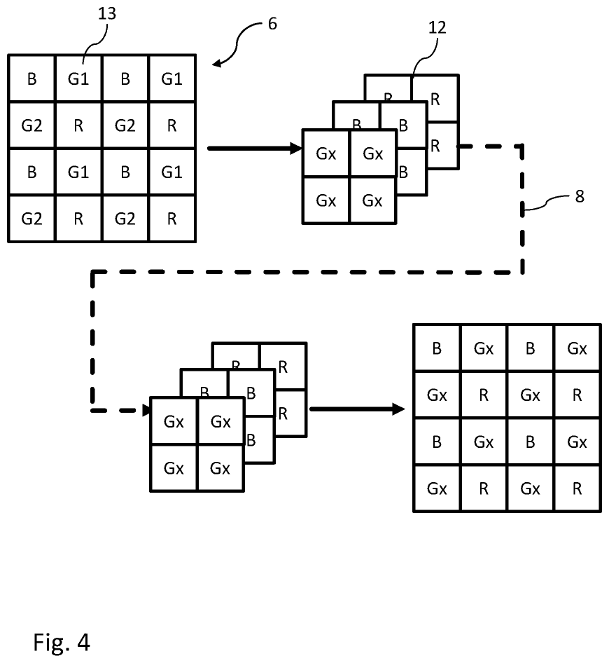

FIG. 4 shows a method for reducing the color depth. The image sensor 6 has a Bayer color filter in this example, too. Here, however, for each pixel 12, the two green values G1 and G2 of the respective subpixels are not transferred via the transmitter 2, rather only one green value Gx is communicated. The latter can be one of the two green values G1 or G2 or a mean value formed therefrom. In the receiver 3, the one green value Gx is set for both green values G1 and G2, such that a Bayer pattern arises again. In this way, however, instead of four color values, only three color values per pixel are to be transferred, as a result of which the data rate can be reduced by 25%.

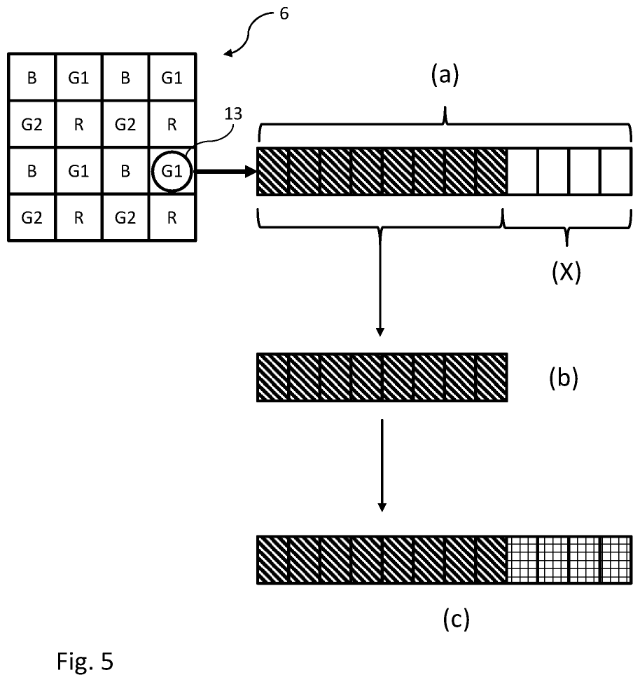

FIG. 5 shows a further method for reducing the color depth. In the example, each subpixel 13 of the image sensor 6 is quantized with a color depth of 12 bits (a). The least significant bits often contain image noise that is not relevant to the finished image. In order to reduce the data rate, in the example, the four least significant bits (X) are cut off and only the more significant eight bits are transferred. In the receiver, the four bits cut off are added and padded by white noise or in some other way. The advantage here is that in the example the data rate is reduced by 33% without significant loss of image quality. The advantage over a true 8-bit color depth consists in the higher resolution as a result of the 12-bit digitization.

### LIST OF REFERENCE SIGNS

1 Device
2 Transmitter
3 Receiver
4 Data transfer connection
5 Supervisory connection
6 Image sensor
7 Control unit
8 Raw image data stream
9 Control commands
10 Image processing unit
11 Video image data stream
12 Pixel
13 Subpixel

1. A method for transferring a raw image data stream (8) from an image sensor (6) via a data transfer connection (4) between a transmitter (2) and a receiver (3), the method comprising:
determining (S1) a current latency of the data transfer connection (4), and
adapting (S3) a data rate of the raw image data stream (8) at the transmitter (2) depending on the determined current latency.

2. The method as claimed in claim 1, further comprising reducing the data rate if the current latency exceeds a latency limit value, in particular wherein the data rate is reduced further as latency increases.

3. The method as claimed in claim 1, further comprising regularly or continuously repeating the determining and adapting steps.

4. The method as claimed in claim 1, further comprising the determining of the current latency being determined at the receiver (3), and providing a supervisory connection (5) between transmitter (2) and receiver (3), the receiver transferring supervisory data via the supervisory connection to the transmitter (2), and the adapting of the data rate at the transmitter (2) is effected based on the supervisory data.

5. The method as claimed in claim 1, wherein adapting the data rate is effected by changing at least one of a resolution, a color depth or a frame rate.

6. The method as claimed in claim 5, wherein adapting the resolution is effected by reconfiguring the image sensor (6).

7. The method as claimed in claim 5, wherein adapting the color depth is effected by digitizing color values with a smaller number of bits.

8. The method as claimed in claim 5, wherein the transmitter (2) adapts the color depth per color value by cutting off one or more less significant ones of the bits and the receiver adds missing bits with virtual noise.

9. The method as claimed in claim 5, wherein adapting the data rate is effected by combining pixels that occur characteristically redundantly in a pixel pattern.

10. The method as claimed in claim 1, wherein the data transfer connection (4) is a wireless data connection.

11. A device (1) for transferring a raw image data stream (8) from at least one image sensor (6) via a data transfer connection (4) between a transmitter (2) and a receiver (3), the device comprising
a processor configured to determine a current latency of the data transfer connection (4), and
the processor being further configured to adapt a data rate of a raw image data stream (8) at the transmitter (2) depending on the determined current latency.

12. The device (1) as claimed in claim 11, wherein the processor that is configured to determine the current latency is arranged at the receiver (3) and the device further comprises a supervisory connection (5) between transmitter (2) and receiver (3), via which supervisory connection the receiver (3) is configured to transfer supervisory data to the transmitter (2).

13. The device (1) as claimed in claim 12, wherein the transmitter (2) has an image sensor (6) and the image sensor (6) is configurable based on the supervisory data.

14. The method of claim 2, further comprising reducing the data rate further as latency increases.

15. The method of claim 4, wherein the supervisory data comprises at least one of the determined latency or control data.

16. The method of claim 5, wherein the changing is locally weighted in the image.
